(19) United States
(12) Patent Application Publication
(10) Pub. No.: US 2025/0337762 A1
(43) Pub. Date: Oct. 30, 2025

(54) ANOMALY DETECTION IN NETWORK TRAFFIC DATA

(71) Applicant: Armis Security Ltd., Tel Aviv-Jaffa (IL)

(72) Inventors: Bar Keisar, Tel Aviv (IL); Gabi Burabia, Tel Aviv (IL); Elad Ben Akoune, Tel Aviv (IL); Michal Tzur-Hilleli, Tel Aviv (IL)

(21) Appl. No.: 19/188,840

(22) Filed: Apr. 24, 2025

Related U.S. Application Data
(60) Provisional application No. 63/638,390, filed on Apr. 24, 2024.

(51) Int. Cl. H04L 9/40

(52) U.S. Cl. CPC H04L 63/1425; H04L 63/1416

(57) ABSTRACT

This disclosure relates to systems, methods, and devices for identifying anomalous network activity. In some embodiments, a baseline model is used for identifying anomalous network activity. In some embodiments, anomalous network activity is detected based on a z-score, modified z-score, or both being above respective thresholds when compared to the baseline. In some embodiments, multiple baseline models are used, and anomalous network activity is detected when multiple baseline models identify a network activity session as anomalous. In some embodiments, two baseline models are used.

### TECHNICAL FIELD

Embodiments of the disclosure generally relate to anomaly detection in cybersecurity. More specifically, some embodiments of the disclosure relate to anomaly detection based on network traffic data, such as traffic volume (e.g., asset traffic volume).

### BACKGROUND

Cybersecurity tools have traditionally focused on detecting known suspicious and malicious behaviors and typically are not well-suited for detecting unknown ones. Anomaly detection is a threat detection field intended to detect unknown attack patterns, and very often, anomaly detection involves the detection of behavior that deviates significantly from some established baseline of behavior.

Although some cybersecurity tools now claim to implement anomaly detection features and methods, the approaches used are often lacking. For example, some cybersecurity tools may rely on a “static” baseline model that is tied to a specific point in time. More specifically, a set time window may be used for training a baseline model, after which the training flag is disabled, and the baseline model is used for anomaly detection. However, this approach does not fit the dynamic nature of devices and their changing behavior over time.

As another example, some cybersecurity tools utilize a set of hardcoded parameters for anomaly detection, such as by looking for certain indicators of compromise (IoCs), operations, packet patterns, etc. However, these are simply threat detection methods couched as anomaly detection. Instead of looking for known attacks, anomaly detection should be generic enough to detect the unknown.

As yet another example, some cybersecurity tools will utilize approaches that will detect a large number of potential anomalies, resulting in the generation of an overwhelming amount of alerts. This can result in alert fatigue-if a solution is not able to provide only the most accurate, most prioritized detections, the solution becomes less relevant as users are sometimes overwhelmed with the amount of detections generated.

Accordingly, there exists a need for an approach to anomaly detection that is dynamic in nature (e.g., does not rely on a static baseline model), is sufficiently broad and generic to identify various kinds of unknown behavior, and can provide only accurate and prioritized detections.

### SUMMARY

For purposes of this summary, certain aspects, advantages, and novel features are described herein. It is to be understood that not all such advantages necessarily may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

All of the embodiments described herein are intended to be within the scope of the present disclosure. These and other embodiments will be readily apparent to those skilled in the art from the following detailed description, having reference to the attached figures. The invention is not intended to be limited to any particular disclosed embodiment or embodiments.

Systems and methods for anomaly detection are disclosed herein. A baseline may be established for any communication between a client and server. Data models may be used to alert on deviations from this baseline; given a device's baseline, any anomalies or deviations from the baseline exhibited in the device's behavior can be identified. These detections can be used to increase security coverage and provide a lead, serving as an indication that something abnormal has happened.

To address the limitations in traditional anomaly detection, some embodiments disclosed herein include an anomaly detection system that can increase security coverage by providing a lead or indication of abnormal behavior in network traffic and devices. The anomaly detection system can leverage a traffic volume parameter, which can encompass inbound network traffic, outbound network traffic, or both. Some embodiments utilize other network traffic parameters such as, for example and without limitation, bandwidth, throughput, data rate, packet rate, packet size, latency, round trip time, jitter, packet loss, error rate, retransmissions, quality of service indicators, protocol (e.g., TCP, UDP, ICMP), port usage, traffic type (e.g., web browsing, email, file transfers, video streaming, music streaming) etc. In some embodiments, network traffic is grouped into sessions. In some embodiments, sessions are further grouped. Sessions can have a fixed time in some embodiments, such as fifteen minutes, an hour, a day, a week, etc. By defining a session as an aggregation of network traffic between a host and a device over a defined period of time, the anomaly detection system can gain insights into communication patterns within the network environment. The anomaly detection system can mitigate or eliminate some limitations associated with static baseline models and offers improved security coverage and perspective on normal and abnormal network traffic behaviors.

In some embodiments, the anomaly detection system utilizes baseline data collection over a period of time. In some embodiments, the period of time for the baseline data can have a minimum, a maximum, or both. For example, the anomaly detection system may require a dataset that spans a minimum of 30 days of interaction data between the device and one or more host, or between a host and one or more devices. In some embodiments, the interaction data may last over a six-month period at most or a three-month period at most. In some embodiments, the baseline data collection spans three months or about three months. These are merely examples, and the period of time for baseline collection can be any suitable time range and can vary depending on the specific implementation and may, in some cases, be less than thirty days or more than six months. In some cases, a device and host may not communicate every day; thus, for example, a baseline data requirement may require N days of interaction data over a period of M total days, where N and M are positive nonzero integers and generally N≤M. The dataset requirement can help ensure that the anomaly detection system understands typical traffic volumes and interaction patterns. The dataset may provide a foundation for model training, which can increase the accuracy of anomaly identification, classification, or both. In some embodiments, baseline data is updated periodically, in an ad hoc manner, or both.

In some embodiments, the anomaly detection system employs one or more models (e.g., clustering algorithms) such as k-means, DBSCAN, or OPTICS for clustering. For example, k-means is an unsupervised clustering algorithm designed to partition a dataset into k clusters, wherein each cluster represents a group of data points that are similar to each other. K-means clustering minimizes the distance between data points within the same cluster while maximizing the distance between different clusters. The distance between clusters or the distance of specific points from certain clusters can be used for anomaly detection. For example, anomalies can be identified as data points that are significantly different from the majority of the dataset. By utilizing the distance of each data point to the nearest cluster (e.g., to a centroid of the nearest cluster), k-means clustering can be used to identify data points (e.g., network activities) that lie far away from the cluster's centroid, which can indicate anomalous—and potentially malicious or unauthorized—behavior.

A k-means clustering algorithm can cluster data into a predefined number of clusters k, assigning each data point to the nearest cluster centroid based on a chosen distance metric (e.g., Euclidean distance, Manhattan distance, cosine similarity, Mahalanobis distance). A system can be configured to calculate the distance of each data point to the centroid the data point's assigned cluster. This distance acts as a metric for determining the fit of the data point within the cluster. An anomaly threshold can be established, for example based on statistical methods or domain knowledge. Data points with distances that exceed this threshold can be identified as anomalies.

In some embodiments, OPTICS is used for clustering. OPTICS can several advantages. For example, unlike k-means clustering, there is no need to specify the number of clusters in advance. Additionally, unlike DBSCAN, there is no need to specify a fixed distance threshold. Fixed numbers of clusters, fixed distance thresholds, or both may not be well-suited to generalizing to different environments with different data scales, density, diversity, and so forth. OPTICS can be preferable in some embodiments because it is more robust and adaptable than some other clustering approaches, and OPTICS may involve reduced manual parameter tuning.

In some embodiments, the anomaly detection system incorporates methods such as z-score and modified z-score for anomaly scoring. A z-score indicates how many standard deviations a data point is from the mean of a dataset. Modified z-scores operate using the median and median absolute deviation rather being mean-based, which can make it less sensitive to outliers than standard z scores. Using such methods can enable an anomaly detection system to adapt to variations in traffic volumes or density and/or network complexities. An anomaly detection system according to the present disclosure can be used for detecting known threats, identifying unknown or emerging threat patterns, or both, which can significantly enhance overall security coverage.

A z-score is a statistical measure used to determine how much a data point deviates from the mean of a dataset, expressed in terms of standard deviations. The z-score can be applied in anomaly detection to identify deviations from expected network behavior. A high z-score indicates that a data point significantly differs from the baseline, suggesting a potential anomaly such as an unusual spike in network traffic. However, the z-score is sensitive to outliers because the calculation relies on the mean and standard deviation, which can be distorted by values from outliers.

To address the z-score limitation, a modified z-score uses the median and the median absolute deviation (MAD) instead of the mean and standard deviation. The modified z-score is more effective in datasets that contain outliers or have skewed distributions. In some cases, the modified z-score can have advantages in cybersecurity applications where network traffic can fluctuate unpredictably. By comparing observed traffic volumes to a dynamic baseline, the modified z-score helps reduce false positives while still detecting significant anomalies.

The z-score and modified z-score, separately or in combination, can be used for anomaly detection by allowing for identification of deviations in network traffic. In some embodiments, anomalies are detected based on either the z-score or the modified z-score (e.g., when the z-score is above a first threshold or the modified z-score is about a second threshold). In some embodiments, anomalies are detected when both the z-score and the modified z-score are above respective thresholds. In some embodiments, anomalous network activity is detected in real time or nearly real time. In some embodiments, anomalous network activity is detected based at least on detecting deviations from statistical norms. With particular reference to network traffic, the z-score, modified z-score, or both can be applied to features such as packet size, connection frequency, latency, dropped packet rate, transfer speed, or data transfer volume to determine whether a specific observation or multiple observations statistically deviate from a baseline or recent history. For example, a high z-score can indicate an abnormal spike in outbound traffic, which could signal potential security threats such as data exfiltration, unauthorized file transfers, or irregular communication patterns. When the z-score, modified z-score, or both are used in combination with clustering algorithms such as DBSCAN or OPTICS, the integration can improve the accuracy of anomaly detection, as described in more detail herein. Furthermore, the integration provides statistical measures to help isolate outliers more effectively by distinguishing between expected variations in traffic and suspicious activity. The integration can enable the system to prioritize alerts based on statistically significant deviations, which can improve overall security monitoring and threat response.

### BRIEF DESCRIPTION OF THE DRAWINGS

These and other features, aspects, and advantages of the disclosure are described with reference to drawings of certain embodiments, which are intended to illustrate, but not to limit, the present disclosure. The accompanying drawings, which are incorporated in and constitute a part of this specification, are for the purpose of illustrating concepts disclosed herein and may not be to scale.

FIG. 1A illustrates how a dataset can be collected from network traffic data associated with a device-host pair, in accordance with embodiments of the present disclosure.

FIG. 1B illustrates how a dataset can be collected from network traffic data associated with a device and all hosts, in accordance with embodiments of the present disclosure.

FIG. 1C illustrates how a dataset can be collected from network traffic data associated with a device and all hosts, in accordance with embodiments of the present disclosure.

FIG. 2A illustrates an example data table associated with sessions between a device-host pair, in accordance with embodiments of the present disclosure.

FIG. 2B illustrates an example data table displaying unsorted sessions between many different devices and hosts, in accordance with embodiments of the present disclosure.

FIG. 3 illustrates an overview of how different baselines can be used to detect anomalies in different situations, in accordance with embodiments of the present disclosure.

FIG. 4A illustrates an overview of how baseline models can be used for anomaly detection, in accordance with embodiments of the present disclosure.

FIG. 4B illustrates an example cluster unification process according to some embodiments.

FIG. 5A is a graph showing example traffic volumes between a device and various hosts over a period of time.

FIG. 5B is a graph showing example traffic volumes between various device-host pairs over a period of time, in which anomalous traffic is identified according to some embodiments of the present disclosure.

FIG. 5C illustrates two graphs that illustrate analysis of network traffic according to some embodiments of the present disclosure.

FIG. 6 illustrates an analysis of network traffic data using two anomaly detection models according to some embodiments of the present disclosure.

FIG. 7 illustrates analysis of network traffic in accordance with some embodiments described herein.

FIG. 8 is a block diagram that illustrates an example process for classifying a session according to some embodiments.

FIG. 9 is a block diagram depicting an embodiment of a computer hardware system that can be configured for performing one or more embodiments of the present disclosure.

### DETAILED DESCRIPTION

Although several embodiments, examples, and illustrations are disclosed below, it will be understood by those of ordinary skill in the art that the present technology extends beyond the specifically disclosed embodiments, examples, and illustrations and includes other uses and obvious modifications and equivalents thereof. Embodiments of the present technology are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments can include several novel features and no single feature is solely responsible for its desirable attributes or is essential to practicing the inventions herein described.

As used herein, the term “session” may refer to network traffic data between a host and device that is aggregated over a time period. For example, in some embodiments, a session may be an hourly traffic aggregation between a host and a device. In some embodiments, an anomaly detection approach may involve identifying anomalous sessions.

The terms “device,” “host,” “client,” “server” and similar language is used herein for ease of understanding. However, it will be appreciated that these terms should not be construed as limiting, but rather can refer to any asset, endpoint, host, domain, device, etc., for which network activity can be monitored, unless the context clearly indicates otherwise.

Many approaches to anomaly detection suffer from issues that can make them less effective or less desirable for use by security professionals. For example, many anomaly detection approaches suffer from high false positive rates, incorrectly identifying normal behavior as anomalous and potentially resulting in alert fatigue, in which security professionals or other users learn to ignore alerts. Many approaches also fail to account for evolving data patterns, such that a baseline becomes outdated as a device's behavior changes over time, resulting in degraded detection performance (e.g., greater false positive rate). Many approaches also fail to account for behavior that is normal but relatively rare, such as network activities that occur only once per month, once per quarter, etc. Many approaches also struggle with scaling to handle large volumes of data in real-time or nearly real-time. The approaches described herein can address issues with more conventional anomaly detection techniques, resulting in improved anomaly detection and improved computer security.

In some embodiments, the systems and methods described herein involve approaches to anomaly detection. In some embodiments, an anomaly detection approach involves a dynamic baseline. New behaviors may be taken into account, alerted on, and even calculated into the baseline if they repeat over time. In some embodiments, the dynamic baseline may utilize a “sliding window” approach. For example, the dynamic baseline may be based on data collected over a shifting period of time, such as a 6-month window. The size of the sliding window can be significant, as too long of a window can result in less sensitivity to changes in the baseline, while too short of a window can introduce noise as behaviors that are relatively infrequent, yet recurring, may not be properly accounted for in the baseline. For example, a 6-month, dynamic baseline may reduce the noise from behaviors that are repetitive but which occur infrequently as such patterns can still be captured over the longer observation period using the datasets described herein.

While a dynamic baseline offers many advantages as described herein, the dynamic baseline can be more difficult to store and maintain as compared to a static baseline. Using dynamic baselines can involve various actions such as associating behavioral data with unique device identifiers to maintain continuity as a device's properties or usage patterns evolve. By assigning each device a unique identifier, the system can accurately track behavioral trends and update the baseline over time. Using unique device identifiers can allow the dynamic baseline to evolve in a stable and consistent way, without mixing the behavioral data from different devices. Unique device identifiers can be of utility for detecting anomalies, as behavioral patterns can be attributed to the correct device for accurate modeling and comparison.

An asset-centric approach can be used, in which the system maintains an asset inventory (e.g., an inventory of devices within a monitored environment). In some embodiments, the system collects device behavior data (and more specifically network communication data in some embodiments) over time. For example, the system can monitor and analyze device traffic to extract various parameters such as traffic volume, ports, protocols, client identifiers, server identifiers, number of network hops, etc., from the stored network communication data. The parameters (e.g., traffic volume, client identifiers, and server identifiers) can be compiled into datasets used to establish behavioral baselines for each device and anomaly detection. Maintaining such baselines over extended time periods (e.g., one or more months) can require significant storage resources, particularly when monitoring large numbers of devices across an enterprise environment.

The anomaly detection approaches described herein may be sufficiently broad and generic to enable detection, identification, or both of various kinds of unknown behavior. In some embodiments, the approach may utilize dataset(s) that describe any device's traffic, for any type of traffic that is transmitted over a network (e.g., an IP network), over a long period of time (e.g., many weeks or months, such as one week, two weeks, three weeks, one month, two months, three months, four months, five months, six months, or more). The anomaly detection approaches herein can be device-agnostic or can be tailored for specific devices or types of devices. For example, an anomaly detection approach can work the same way for all devices, across all ports and protocols. For example, an anomaly detection approach may treat a laptop (Information Technology (IT) device) the same way the anomaly detection approach treats an MRI scanner (medical device) or a programmable logic controller (PLC) (operational technology (OT) device). A device-agnostic approach to anomaly detection can be enabled using various datasets described herein, which may contain information about any type of asset and asset behavior (e.g., IT, internet of things (IoT), Medical, OT).

The anomaly detection approaches described herein may reduce noise and alert fatigue as compared with other approaches that can produce more false alerts. In some embodiments, a user interface, alert mechanism (e.g., push notifications, text messages, etc.) can highlight or otherwise draw attention to the highest confidence anomalies observed in an environment. The highest confidence anomalies can be determined by taking into account the anomaly and the device on which the anomaly is detected, and calculating how anomalous the anomaly is compared to similar anomalies on other devices in the same environment. In some embodiments, a long period for baselining (e.g., 6 months), as well as the use of a dynamic “sliding window” baseline enables the reduction in the confidence of repeating but infrequent behaviors being identified as anomalous, as well as enabling new behaviors to be learned over time and not alerting on them. For example, if a certain behavior is observed with more than a threshold frequency or more than threshold number of times over a dynamic baseline, the behavior may not be identified as anomalous, or may be identified as anomalous but with a relatively low confidence or likelihood.

In some embodiments, a new detected anomaly is assigned a confidence score. The confidence score can be numerical or categorical (e.g., medium, high, or critical). Confidence scores can be used by users to filter detected anomalies. In some embodiments, users can perform filtering using a query language in addition or as an alternative to filtering based on confidence scores. Filtering using a query language can enable users to more exactly specify the types of anomalies they are looking for, for example based on device type, specific network traffic (e.g., connections to specific servers or IP addresses, or connections using certain protocols). In some embodiments, the anomaly detection approaches herein links traffic from the same device over time even when the device's IP address, name, or other specifications or configurations change, which can provide for a high confidence baseline over a long period of time.

In some embodiments, the anomaly detection approaches herein operate using network traffic data, such as network traffic volume. For example, a baseline of traffic volume for each device-host pair can be established (e.g., a device-host baseline). Traffic volume associated with a specific device can vary based on the host with which the device is communicating. Accordingly, establishing baselines at the device-host pair level can allow more precise modeling of expected communication behavior for each unique device-host pair (e.g., distinct combination of device and host). Such device-host specific baselines can improve anomaly detection accuracy by allowing the system to distinguish between normal host-specific traffic patterns and anomalous activity. As a result, the system can reduce false positives or false negatives classifications of anonymous communication behavior between device-host pairs. Utilizing baselines that are specific to a particular device and host can have certain advantages. For example, consider a mobile phone device. The mobile phone device may send a significantly different type, volume, or both of traffic to a first host as compared with a second host. Device-host specific baselines can make it easier to detect when a device is communicating anomalously with specific hosts. Device-host specific baselines can decrease false positives, decrease false negatives, increase true positive detection rates, or any combination thereof.

The anomaly detection approaches described herein can utilize one or more models. For example, in some embodiments, two models are used. For example, a first model can be used for cases where there is an established device-host baseline, while the second model can be used when there is not an established device-host baseline (e.g., for new or unknown hosts). For new or unknown hosts, a baseline of traffic volume for a generic device may be used. In some embodiments, when the traffic volume observed for a device-host pair is much higher than the traffic volume observed in the baseline, the traffic volume may be considered anomalous, which can cause a system to generate an alert, a detection event, etc. In some embodiments, the detection may have a confidence level (also referred to as a confidence property) that indicates a degree of difference of the detection from the baseline (e.g., the amount of deviation). As described herein, anomaly detection can be specific to a device, host, device-host pair, port, protocol, or any combination thereof. For example, different baselines can be established for different ports, protocols, devices, hosts, and so forth.

In some embodiments, the traffic data between a host and device is aggregated based on a time period, with each aggregation being referred to as a session. For example, a session can be an hourly traffic aggregation between a host and a device. The length of the session can vary and in some cases is user-configurable. A longer length can be beneficial for identifying ongoing anomalous behavior, while a shorter length can be beneficial for detecting relatively short events, such as large data transfers that happen over the course of seconds or minutes. In some embodiments, multiple session lengths are used. Different session lengths can be optimized for detecting different types of anomalous behavior. Various types of data can be associated with a session. For example, session data may include device id, host id, tenant id, traffic volume (inbound, outbound, or inbound and outbound combined) (e.g., in bits, bytes, etc.), timestamp, and so forth. In some embodiments, the anomaly detection approaches herein involve the identification of anomalous sessions.

In some embodiments, the host may be one of two types (e.g., known or unknown), which may affect the dataset(s) used as the baselines for identifying anomalous sessions. For known hosts, there may already be data for one or more days (generally, N days) of traffic between the host and the device that was collected over a baseline period (e.g., in the past 6 months). The values (e.g., N days, baseline period) may be selected based on empirical analysis, industry standards, or otherwise. For example, the values can be 30 days of traffic between the host and the device over a 6-month baseline period. By setting a minimum of 6 points per cluster when clustering data points in a dataset, a system can ensure that behaviors appearing at least once a month over six months are not considered abnormal, thus reducing false positives, and improving the accuracy of anomaly detection. In general, a minimum cluster size A can be used so that behaviors that occur A times or more over the baseline period are not considered anomalous. In some embodiments, A is pre-set. In some embodiments, A is specified in terms of behavior occurrences per month, per week, per baseline period, etc.

For known hosts, two datasets may be involved in the identification of anomalous sessions: a device-host dataset (e.g., sessions between the device and the host) and a host-all devices dataset (e.g., sessions between the host and all other devices in the same tenant, network, subnet, etc.). For unknown hosts, which may be hosts for which data for less than N days of traffic between the host and the device was collected over the baseline period (e.g., in the past 6 months), the device-host dataset may be replaced with a device dataset (also referred to as a device-all hosts dataset). In some embodiments, for unknown hosts, two datasets may be involved in the identification of anomalous sessions: a device-all hosts dataset (e.g., sessions between the device and all other hosts in the same tenant, network, subnet, etc.) and a host-all devices dataset (e.g., sessions between the host and all other devices in the same tenant, network, subnet, etc.).

In some embodiments, for each dataset (depending on the type of the host), the sessions may be clustered based on traffic. For example, sessions may be grouped using clustering algorithms (e.g., centroid-based, density-based, distribution-based, or hierarchical) selected based on the characteristics of the network traffic and the type of cybersecurity threat being detected. The use of clustering enables the system to identify patterns or outliers within the dataset, which may indicate anomalous or unauthorized communication activity.

In some embodiments, the clustering may be based on a density clustering algorithm. Density clustering algorithms operate based on the principle that data points located within a high-density region of a data space separated by areas of lower density belong to the same cluster. Clusters can have arbitrary shapes, provided that the dense regions are connected. For example, a density clustering algorithm that can manage datasets and extract spatial data with varying densities and shapes is the Ordering Points To Identify the Clustering Structure (OPTICS) algorithm. OPTICS operates similarly to the more commonly used density-based clustering algorithm, DBSCAN, but may perform better in some circumstances as OPTICS does not require specifying a fixed distance threshold for cluster formation

In some embodiments, the OPTICS algorithm is applied to a dataset that includes a set of data points (e.g., unordered) to determine the clustering structure of the dataset. The OPTICS algorithm can require two parameters, epsilon and minPts, to compute the set of unordered data points in space. The first parameter, epsilon, defines the maximum distance between neighboring points to be considered part of the same cluster. The second parameter, minPts, specifies the minimum number of points required to form a dense region (e.g., core points). For each data point in the dataset, the OPTICS algorithm can compute a core-distance which corresponds to the minimum distance required for the data point to have at least minPts neighboring data points within the neighborhood centered on the data point. The OPTICS algorithm can compute the reachability-distance for each data point. The reachability-distance can represent the distance by which the data point is density-reachable from a neighboring core point.

Based on the computed core-distances and reachability-distances, the OPTICS algorithm can generate an ordered sequence of data points that reflects the density-based structure of the dataset. The OPTICS algorithm can also generate a reachability plot that represents the reachability-distances of the ordered data points. In the reachability plot, valleys that correspond to regions of low reachability-distance can indicate dense clusters, while peaks or sharp increases in reachability-distance may identify transitions between clusters or regions of low density. Data points that indicate high reachability-distances relative to adjacent data points can be identified as noise. Clusters can be determined by analyzing contiguous regions of the reachability plot that correspond to sequences of data points with relatively low reachability-distances.

In some embodiments, the sessions from the top clusters (based on traffic) may be identified and their traffic values may be used to calculate z score and modified z score thresholds. In some embodiments, a session may be identified as anomalous when a z-score or a modified z-score calculated for the session's traffic volume with respect to one or more baseline datasets (e.g., depending on the type of host), exceeds a predetermined threshold. The criteria for detecting anomalies for a session depends on the specific embodiment. For example, for a known host, if a session has traffic greater than either or both the device-host sessions thresholds (e.g., the thresholds based on the device-host dataset) and host-all devices sessions thresholds (e.g., the thresholds based on the host-all devices dataset), then that session would be anomalous. In another example, the criteria for detecting anomalies in top clusters requires both z-score and modified z-score to be above their respective thresholds.

In some embodiments, the anomaly detection approach involves a dataset that contains network traffic data for all the traffic of a tenant (e.g., between all the devices for a tenant and all the hosts that were communicated with). This dataset may allow for the creation of baselines for device-host pairs, device-all hosts, and host-all devices. In some embodiments, the use of multiple baselines may help reduce noise and alert fatigue that may occur when there are too many false positives (e.g., activity flagged as anomalous but which is actually normal or otherwise benign). Network traffic may have many “anomalies,” but most of them may not be of interest as they do not indicate malicious or otherwise suspicious behavior. The use of multiple baselines can help to identify anomalies that are most likely to be indicative of malicious or other unauthorized activity.

Anomaly detection may be based on the traffic volume parameter only. The traffic volume parameter may consist of inbound traffic volume combined with outbound traffic volume. In some embodiments, the available data for a known host may be a minimum of 30 days of traffic between device and host over a period of 6 months, 30 days over 3 months, or any other values. In some embodiments, data may be grouped hourly by device and tenant and host into sessions. This is merely an example. In some embodiments, outbound and inbound traffic are considered separately, or only inbound traffic is considered, or only outbound traffic is considered.

While the approaches herein can be effective for identifying anomalies, it will be appreciated that errors may still occur. Accordingly, in some embodiments, a system utilizes an anomaly validation check. The anomaly validation check can be used to determine if anomalies for a particular combination (e.g., for a host-device pair) are considered valid or invalid. As an example, all anomalies detected for the combination can be marked as invalid when the percent of anomalies exceeds a threshold (e.g., “Anomalous Sessions”/“Total Sessions”>Threshold) and the number of anomalies is greater than a second threshold. The first threshold can be, for example, 70%, 75%, 80%, 85%, 90%, 95%, etc. The second threshold can be, for example, 5 anomalies, 10 anomalies, 15 anomalies, etc. In some embodiments, the validation thresholds can be customized over time, depending upon the particular deployment, etc. In some embodiments, a system is configured to automatically adjust validation thresholds over time.

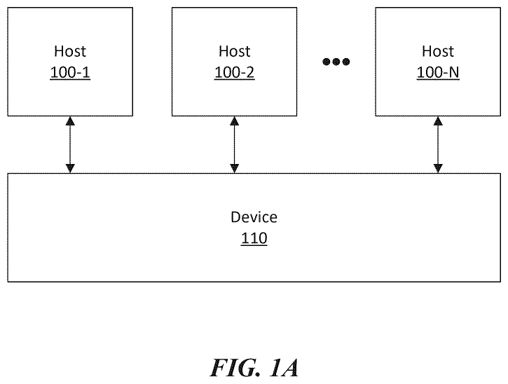

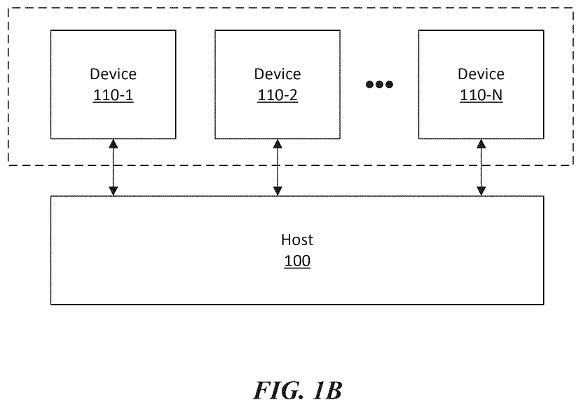

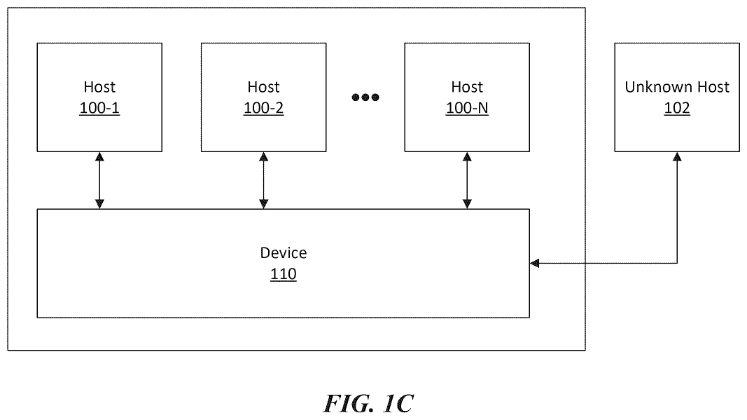

Turning now to the figures, FIG. 1A illustrates how a dataset can be collected from network traffic data associated with a device-host pair, in accordance with embodiments disclosed herein.

Over a period of time, a device 110 may communicate with one or more hosts (illustrated by hosts 100-1, 100-2, 100-N). N can be any positive integer. For any particular host, the network traffic data from all or a portion of the communication sessions between that host and the device 110 may be collected and recorded over a period of time. Accordingly, for any given device (e.g., device 110) there may be a dataset collected for each device-host pair (e.g., the device 110 and any unique host the device 110 communicated with over the period of time). For example, the dataset associated with the device-host pair of device 110 and host 100-1 may be collected from communication sessions between device 110 and host 100-1 over the period of time. This type of dataset can be referred to as a “host-device pair” dataset.

FIG. 1B illustrates how a dataset can be collected from network traffic data associated with a device and all hosts, in accordance with embodiments disclosed herein.

Over a period of time, any particular host (e.g., host 100) may communicate with one or more devices in the same tenant (illustrated by devices 110-1, 110-2, . . . 110-N). The network traffic data from all of the communication sessions between that host and all the devices in the tenant that were made in the period of time may be collected and recorded. Accordingly, for any given host (e.g., host 100), there may be a dataset collected from communication sessions between that host and all the devices over the period of time. This type of dataset can be referred to as a “host-all devices” dataset.

FIG. 1C illustrates how a dataset can be collected from network traffic data associated with a device and all hosts (e.g., all known hosts), in accordance with embodiments disclosed herein.

Over a period of time, a device 110 may communicate with one or more hosts. For any particular host, the network traffic data from all of the communication sessions between that host and the device 110 may be collected and recorded.

In some cases, one or more of the hosts may be unknown (e.g., unknown host 102). In some embodiments, the unknown hosts may be hosts for which data for less than X days of traffic between the host and the device was collected over the baseline period (e.g., in the past 6 months), such as may be the case if the device only recently began communicating with the unknown host. To address such cases, the network traffic data from the communication sessions between the device 110 and all other known hosts (e.g., hosts 100-1, 100-2, . . . 100-N) may be collected and recorded. Accordingly, for any given device (e.g., device 110) there may be a dataset collected from communication sessions between that device and all hosts over the period of time. In some embodiments, this dataset may be the combination of all the device-host pair datasets associated with the device (e.g., for device 110, the datasets for the device-host pairs of device 110-host 100-1, device 110-host 100-2, etc.). In some embodiments, this type of dataset may be referred to as a “device” dataset or a “device-all hosts” dataset. In some embodiments, the “device-all hosts” dataset only includes information about communications between a device and known hosts, but does not include information about unknown hosts. In some embodiments, the “device-all hosts” dataset includes communications data between a device and both known and unknown hosts.

As described herein, the term “session” may refer to network traffic data between a host and device that is aggregated over a time period or from a start of a communication between a host and a device to an ending point of the communication between the host and the device. For example, a session may be an hourly traffic aggregation between host and device. In some embodiments, the data for a session includes device id (e.g., an identifier associated with the device of the session), host id (e.g., an identifier of the host), tenant (e.g., an identifier to distinguish between multiple entities that the device belongs to), timestamp (e.g., the date and time associated with the session), and traffic (e.g., the amount of network traffic between the host and device during the session. In some embodiments, inbound and outbound traffic are included in a total traffic amount. In some embodiments, inbound and outbound traffic are recorded separately. For example, traffic from a device to a host can be recorded separately from traffic from the host to the device. In some embodiments, “tenant” may refer to an entity such as an organization, business unit, or customer account that is associated with one or more devices communicating over the network. Tenant may refer to, additionally or alternatively, a set of endpoints (e.g., servers, desktops, laptops, IoT devices, industrial equipment, medical equipment, etc.).

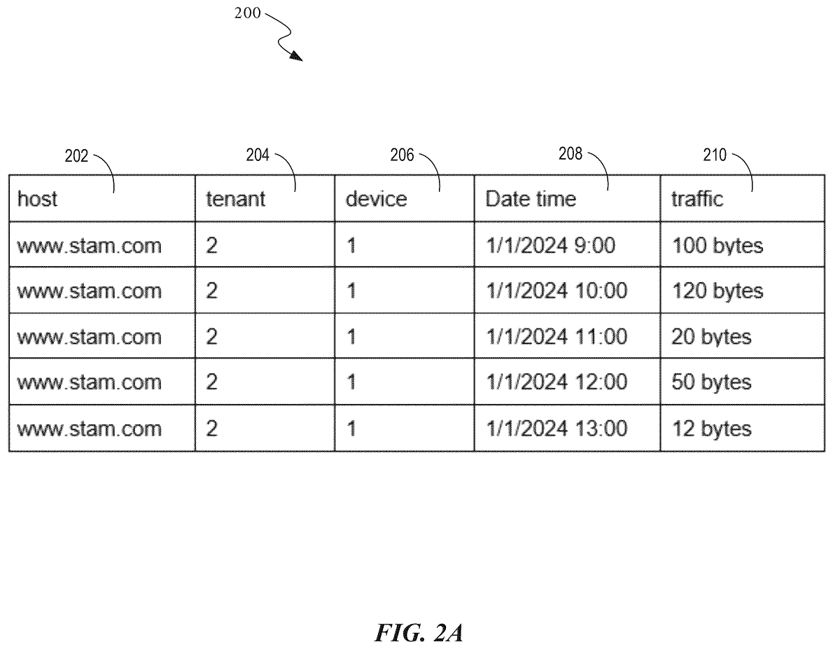

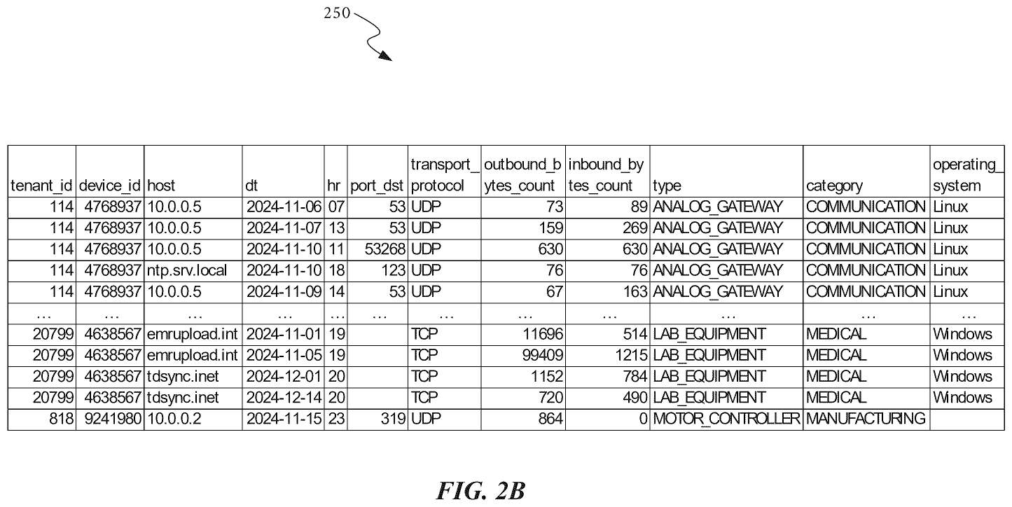

An example data table 200 is shown in FIG. 2A with data collected from different sessions For example, in FIG. 2A, a session is defined as a one hour period, and each row of the table 200 corresponds to a different session (e.g., hour-long time window) between the host and device. Column 202 shows the host for each session, column 204 shows the tenant (e.g., the tenant associated with the device) for each session, and column 206 shows the device id for each session.

Column 204 can identify the tenant associated with each recorded session. In a computing environment with multiple tenants, the various entities may operate within the same system and shared infrastructure. The inclusion of tenant identifiers can allow the system to associate session data with a specific tenant, thereby allowing network traffic to be analyzed and monitored on a per-tenant basis. This per-tenant segregation can support the generation of accurate behavioral baselines and provide anomaly detection tailored to each tenant's network characteristics. In the example of FIG. 2A, the values for these columns are the same across all the sessions because all the sessions correspond to same device-host pair; however, it will be appreciated that a data table may contain information for multiple combinations of host, tenant, and device. Column 208 shows a timestamp for each session, which may be, for example, the date and time that each session began. For example, the first row corresponds to the session that begins at 9:00 on January 1 (e.g., the hour long time window between 9:00 and 10:00). Column 210 shows the traffic in bytes for each session, with the inbound and outbound traffic summed together (though, as described herein, in some embodiments, inbound and outbound traffic are not combined).

FIG. 2B illustrates an example data table displaying unsorted sessions between a variety of devices and hosts. Data table 250 shows more details for each session in comparison to data table 200. In addition to tenant id, device id, host, and timestamp (e.g., the particular date and starting hour associated with each session) for each session, data table 250 also includes a port, transport protocol, outbound data volume, inbound data volume, device type, device category, and device operating system. Capturing additional data, as shown in data table 250, can be beneficial as devices within particular categories or having the same or similar types may be expected to behave similarly. Likewise, devices running the same operating system may show similar behavior such as connecting to the same update servers.

The tenant ID parameter may consist of an identifier for the tenant or organization to which the device belongs. Each tenant can correspond to a distinct operational environment such as a corporate network, industrial facility, hospital system, etc. Devices within a tenant can follow distinct traffic patterns based on the tenant's operational environment and typical network activity. By analyzing traffic at the tenant level, the anomaly detection system can establish baselines that reflect normal communication behaviors within each organization. For example, a medical institution's network traffic may exhibit patterns distinct from those of a manufacturing facility or an IoT-based communication network. Any significant deviation from a tenant's expected communication profile, such as a sudden spike in outbound traffic from multiple devices within a tenant, may indicate a coordinated attack, data exfiltration, or an infected device propagating malware within the network. The dataset in the figure includes multiple tenants (e.g., Tenant 114 and Tenant 20799), allowing for per-tenant anomaly detection.

The device identifier parameter may consist of unique identifiers for the device (e.g., ID for Advertising (IDFA), Google Advertising ID (GAID), IMEI, MAC address) or other device-specific attributes within the network. By tracking individual device behavior over time, the anomaly detection system can collect data and analyze the data to determine if a specific device has exhibited irregular traffic patterns (e.g., as compared to a baseline). For example, an ANALOG_GATEWAY device may typically communicate using user datagram protocol (UDP) packets on port 53, as shown in table 250. If this device were to suddenly initiate high-volume transmission control protocol (TCP) packet communications on port 443, the deviation could indicate malicious activity, an unauthorized configuration change, or a configuration error. Using device ID-based detection, organizations can quickly isolate and respond to threats originating from specific devices.

The host identifier parameter may consist of a unique or quasi-unique identifier for the host (e.g., a fragment of an IP address that uniquely identifies a host within a network, a full IP address, a system name, a fully qualified domain name, etc.). The host identifier parameter identifies the destination or communication endpoint for a given session. For example, the hosts may be represented by IP addresses (e.g., XXX.XXX.XXX.XXX, where the Xs represent numbers, etc.) or domain names (e.g., xxx.yyy, xxx.ab.cd, etc.). By analyzing the typical interactions between devices and specific hosts, the anomaly detection techniques herein may identify unusual outbound and/or inbound connections. For example, a device that typically communicates with an internal server may suddenly start exchanging traffic with an unknown external host, potentially signaling data exfiltration or a command-and-control (C2) connection. Furthermore, if a known host suddenly experiences a significant increase in inbound requests from multiple devices, the increase may indicate a distributed denial-of-service (DDOS) attack. In data table 250, communications are represented at the device-host level.

The datetime parameter can indicate a date and time when a session began. Datetime-based anomaly detection involves tracking communication sessions over time and analyzing whether traffic patterns align with expected temporal behaviors. The dt (date) and hr (hour) fields in table 250 can be used by an anomaly detection system for time-based communications analysis, for example to detect irregular activities such as out-of-hours traffic spikes, unusual traffic volumes within a session, an unusual increase or decrease in the number of sessions over a longer time period (e.g., over a day or week), or activity surges during non-working hours. For example, if a lab equipment device typically transmits data during daytime working hours, but suddenly starts communicating at midnight, the data transmitted at midnight may indicate unauthorized remote access or malware activity. By leveraging historical usage trends, datetime-based anomaly detection may help flag suspicious activity outside of normal operational periods.

The port number parameter can store the specific ports used for a communication session, indicating the type of service or application. Anomaly detection based on the port numbers parameter focuses on identifying unusual communication channels that may indicate exploitation attempts, lateral movement, protocol abuse, etc.

Each session in a dataset can include the destination port (port_dst) and transport protocol (TCP/UDP), allowing for anomaly detection on a per-port basis. For example, in table 250, the analog gateway device consistently communicates over UDP port 53 (DNS) and UDP port 123 (NTP). If the analog gateway device suddenly starts using TCP port 443 (typically used for HTTPS traffic), the sudden use of a different port could indicate an attempt to bypass security controls or an infected device establishing a command and control (C2) channel. By monitoring port usage patterns, the anomaly detection system can identify devices that exhibit abnormal port activity.

The device type parameter may categorize each device based on the device's function, such as analog gateway, lab equipment, motor controller, medical device, IoT device, laptop, file server, workstation, etc. Each category of device can have particular communication patterns for baseline traffic based on device type. For example, a lab equipment device included in data table 250 primarily communicates over TCP and port 443, whereas a motor controller uses UDP and port 319. If a motor controller suddenly initiates high-volume TCP communications, this behavior can be detected as an anomaly, as industrial controllers typically may not communicate over TCP protocols in standard configurations. Using device-type-specific baselines helps refine anomaly detection, reducing false positives.

In some embodiments, an anomaly detection system may identify anomalous activity using the category parameter, which classifies devices into broader groups such as communication, medical, manufacturing, or industrial control systems. Different categories may exhibit different communications patterns, for example based on a category's industry-specific usage or category-specific usage. For example, the dataset shown in FIG. 2B includes COMMUNICATION devices (e.g., gateways communicating over UDP) and MEDICAL devices (e.g., lab equipment using TCP over port 443). If a COMMUNICATION device suddenly behaves similarly to a MEDICAL device (e.g., transmitting high-volume TCP traffic to cloud-based medical services), the change in device behavior (e.g., anomaly) may indicate a misconfiguration or an unauthorized device reclassification attack. The anomaly detection system can use category-specific traffic models to improve anomaly detection and reduce false positives.

In some embodiments, an anomaly detection system utilizes operating system type to identify anomalous behavior. For example, an operating system type can be Linux, Windows, macOS, Android, IOS, or other OS environments. Within a particular network, organization, etc., devices running the same operating system may behave in similar ways. For example, in FIG. 2B, the Linux device primarily uses UDP, while the Windows-based device utilizes more TCP connections, although it will be appreciated that devices running different operating systems may in general be used for different or similar purposes (e.g., a Linux system being used as a developer workstation may exhibit similar communications behavior as a Windows or macOS developer system). In the example of FIG. 2B, a communication device runs Linux and a medical lab equipment device operates on Windows. If a Windows-based lab device starts generating high-volume UDP traffic, the high-volume UDP traffic may indicate an attempt to bypass firewalls or evade traditional intrusion detection systems. By using OS-specific traffic profiles, the anomaly detection system can detect irregular communication behaviors that deviate from normal operating system functions.

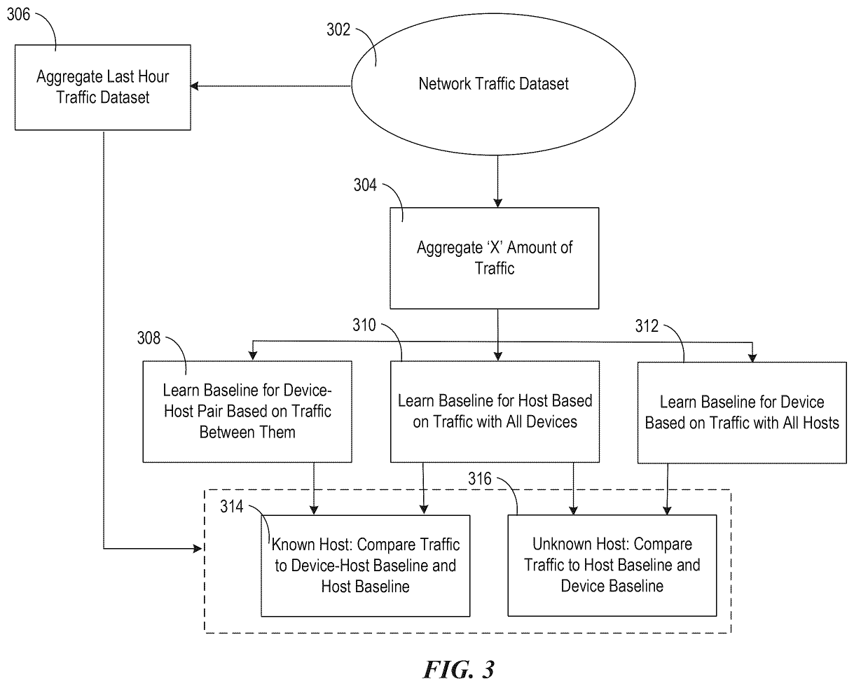

FIG. 3 is a flowchart that illustrates how different baselines can be used to detect anomalies in different situations, in accordance with embodiments disclosed herein.

Over a period of time, a system can monitor network traffic data between various hosts and devices (e.g., of a tenant) may be monitored and captured. This data can be collectively referred to as network traffic dataset 302

At block 304, the system can aggregate the network traffic data in dataset 302 into sessions, for example sessions over a selected or predetermined time period. For example, in some embodiments, a session may be an hourly traffic aggregation between a host and a device. From the aggregated network traffic data, multiple baselines can be determined.

For example, at block 308, the system can determine a device-host baseline for each device-host pair using the data associated with the respective device-host pair (e.g., based on the network traffic between the device and the host). In some embodiments, system the network traffic dataset 302 may be filtered to obtain the data associated with each device-host pair, which can be saved into a device-host pair dataset for the respective device-host pair.

At block 310, the system can determine a host baseline for each host using the data associated with the host (e.g., based on the network traffic between the host and all the devices of the tenant). In some embodiments, the system can filter the network traffic dataset 302 to obtain the data associated with each host, which can be saved into a host-all device dataset for the respective host.

At block 312, the system can determine a device baseline for each device using the data associated with the device (e.g., based on the network traffic between the device and all the hosts). In some embodiments, the system can filter the network traffic dataset 302 to obtain the data associated with each device, which can be saved into a device-all host dataset for the respective device.

Anomalies can then be detected in real-time as network traffic data is continually collected (e.g., into network traffic dataset 302). At block 306, the last hour (or another window of time if some other aggregation period is used at block 304 for each session) of network traffic data can be retrieved (e.g., from the network traffic dataset 302) and aggregated into sessions (e.g., for the different device-host pairs). Accordingly, there will be a ‘last hour’ session for each device-host pair.

For each ‘last hour’ session, if the host is a known host, then at block 314, the system can observe and compare the traffic during the session to both the device-host baseline (corresponding to the device-host pair for that session) and the host baseline (corresponding to the host for that session). The system can determine an anomaly when the observed traffic deviates significantly from either of those baselines (e.g., device-host and host).

If the host is an unknown host, then at block 316, the system can observe and compare the traffic during the session to both the host baseline (corresponding to the host for that session) and the device baseline (corresponding to the device for that session). The system can determine an anomaly when the observed traffic deviates significantly from either of those baselines (e.g., device-host and host).

For example, consider the case in which a mobile phone device communicates with three different hosts—host 1, host 2, and host 3. The average or typical communication that is observed and considered a baseline between the device and host 1 is 10 GB, while between the device and host 2 is 1 MB. In this example, there is no baseline for the communication between the device and host 3 as it is a host for which communications have only been observed very recently. If it is now observed that communication between the device and host 1 is 12 GB, that is not too large a deviation from the baseline (10 GB) and would probably not be considered anomalous. However, a communication between the device and host 2 that is 12 GB would be considered a very large deviation from the baseline (1 MB) and would be considered anomalous. For a communication between the device and host 3 that is 12 GB, whether that would be considered anomalous would further depend on the device's general behavior and baseline.

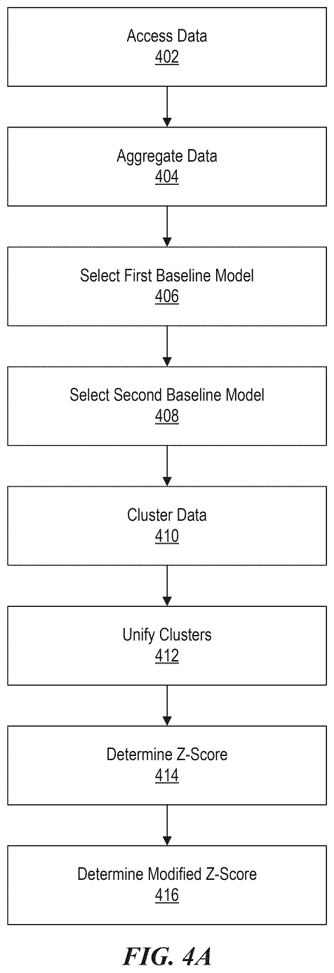

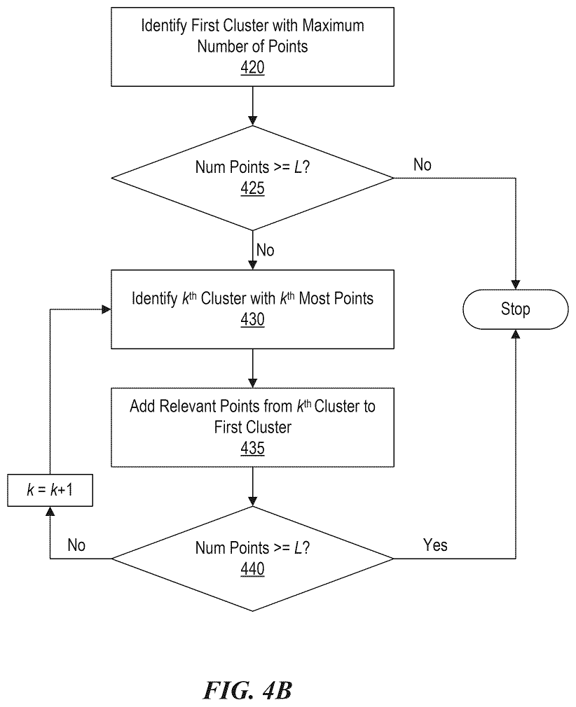

FIG. 4A illustrates an overview of how baseline models can be used for anomaly detection, in accordance with embodiments disclosed herein. Baseline models can be used for anomaly detection for known hosts. For unknown hosts, a similar approach can be used-however the first baseline model (e.g., at block 406) would instead be a device baseline (e.g., based on communications between the device and all known hosts over the baseline period).

At block 402, the system can access network traffic data. In some embodiments, the system can load the network traffic data which can be the unsorted network traffic data collected in an environment (e.g., for all the devices of a tenant and their communications with any hosts) over a large period of time.

At block 404, the system can sort, collect, and aggregate the network traffic data into sessions. For example, a session can be defined as the network traffic (e.g., traffic volume) between a device and a host over an hour-long period. Accordingly, the device, tenant, host, time, or any combination thereof can be used to aggregate the network traffic data into total bytes (e.g., the total amount of traffic volume) by. In some embodiments, the system can aggregate the accessed data in one or more ways, by as by device, by tenant, by host, by port, by protocol, by hour, etc. In some embodiments, the system aggregates the total network traffic volume (e.g., the total inbound traffic, total outbound traffic, or sum of the inbound and outbound traffic).

At block 406, the system can select the first baseline model. Based on the selection, the system can identify all the session's relevant data to include into the first baseline model (e.g., the relevant session data within the baseline period of time). For example, for a baseline model based on traffic between a particular device-host pair, the sessions associated with that device-host pair that fall within the baseline period of time (which can be a shifting window) may be selected by the system.

At block 408, the system can select the second baseline model. Based on the selection, the system can identify all the session's relevant data to include into the second baseline model (e.g., the relevant session data within the baseline period of time). For example, for a baseline model based on traffic between a particular host and all devices of a tenant, all the sessions associated with that host that fall within the baseline period of time (which can be a shifting window) may be filtered for.

The first baseline model from block 406 and the second baseline model from block 408 can serve separate functions in the system. In some embodiments, the first baseline model can be specific to a device-host pair. The first baseline model can be generated from session data between a given device and host. In some embodiments, the second baseline model can be specific to a host and all devices. The second baseline model can be aggregated at the host level and can be generated from session data associated with all devices communicating with the host. Furthermore, the first baseline model and the second baseline model are different by design. The first baseline model can characterize expected network behavior for a specific device-host pair over a defined baseline period, which can help detect anomalies specific to the communication between the device-host pair. The second baseline model can capture and aggregate traffic patterns across all devices interacting with a particular host, allowing identification of anomalies that reflect deviations in host-level behavior. The system can compare the observed traffic against both the first baseline and the second baseline to improve anomaly detection accuracy and reduce false classifications.

At block 410, the session data for each of the models may be separately clustered (e.g., based on traffic volume/bytes) using any suitable clustering algorithm, such as a density-based clustering algorithm. Some examples of clustering algorithms include K-means and DBScan, and OPTICS.

In some cases, there may be challenges associated with handling small clusters. In particular, there may be issues with the reliability of the determined mean and standard deviation. One solution may be to set a minimum number of sessions for the top cluster (e.g., unify clusters). A top cluster can refer to a cluster containing either the highest number of sessions or the sessions determined to represent dominant communication patterns observed during a baseline period. To qualify as a top cluster, the cluster must contain at least a minimum number of sessions, where the minimum is a threshold selected to provide statistical significance or baseline reliability (e.g., a cluster must include at least N-sessions over a period (e.g., six months)). When a cluster does not meet the minimum session threshold, the system can unify that cluster with one or more additional clusters having similar characteristics until the combined group satisfies the required minimum. This approach can ensure the resulting cluster represents baseline behavior and avoids incorrectly classifying low-frequency, expected behavior as anomalous. Accordingly, at block 412, clusters may be unified if needed, although such clustering may not be needed in some embodiments.

At block 414, for each model, a z-score may be determined based at least in part on the clustering results of that model and the session being evaluated (e.g., the traffic volume for the last hour of traffic data, which is being evaluated as anomalous or not).

At block 416, for each model, a modified z-score may be determined based at least in part on the clustering results of that model and the session being evaluated (e.g., the traffic volume for the last hour of traffic data, which is being evaluated as anomalous or not).

In some embodiments, a session (e.g., its traffic volume) may be considered anomalous if the z-score and modified z-score for one of the baseline models are above thresholds. In some embodiments, a session (e.g., its traffic volume) may be considered anomalous if the z-score and modified z-score for both of the baseline models are above thresholds.

In some embodiments, the threshold for the z-score or modified z-score used to identify an anomaly can be set to a value such as 1, 2, 3, or higher. The specific value selected for the threshold has a direct impact on the sensitivity of anomaly detection. For example, a threshold of z=1 may result in a large number of sessions being flagged as anomalous, which could lead to a high rate of false positives. Conversely, a threshold of z=10 is highly restrictive and may cause the system to miss actual anomalies, thereby increasing the risk of false negatives. Typically, thresholds such as z=2 or z=3 are selected to provide a balance between sensitivity and specificity, with z=3 commonly used to identify values that are significantly different from the mean in a statistical dataset.

FIG. 4B illustrates an example cluster unification process according to some embodiments. As described herein, in some cases, it can be desirable to construct clusters with a minimum number of points. For example, if data is collected over a period of six months, and an activity that occurs at least monthly is considered not to be anomalous, a system can attempt to form clusters with at least six points (though not all points may eventually be placed into clusters with six or more points). At operation 420, for a set of clusters, the system can identify a first cluster, the first cluster being the cluster with the maximum number of data points. At operation 425, the system can determine if the number of points in the first cluster is greater than or equal to a minimum threshold L. If so, the process can stop and additional data points are not added to the first cluster. If the first cluster contains fewer than L points, the system can identify the next (kth, where k=2) cluster at operation 430, where the kth cluster includes the kth most data points. The system can add relevant points from the kth cluster to the first cluster at operation 435. Relevant points can be selected according to one or more constraints. For example, relevant points can be defined as points with a difference less than a maximum difference. As an example, when clustering based on data transfer volume, a difference can be a maximum number of bytes minus total bytes. For example the difference can be the maximum number of bytes of a point in the cluster minus the number of bytes for a particular point in the kth cluster. In some embodiments, only points determined to be relevant are added to a cluster.

At operation 440, the system can determine if the number of points (e.g., the number of points in the first cluster after adding the relevant points from the kth cluster) is at least L. If so, the process can stop. If not, the process can continue and add relevant points from the next cluster. The process shown in FIG. 4B can repeated can be repeated for all the clusters in the set of clusters to form as many clusters as possible (within constraints) that have at least L data points.

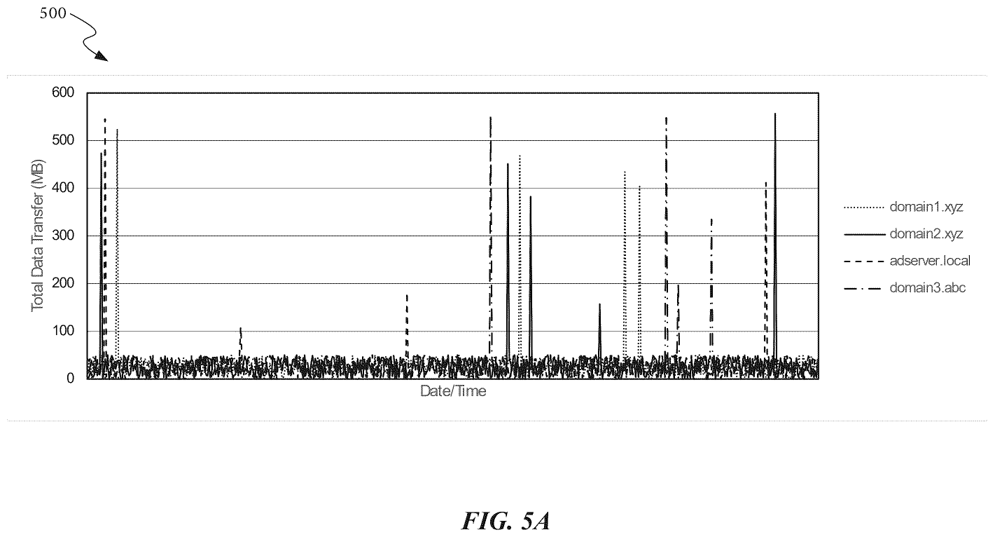

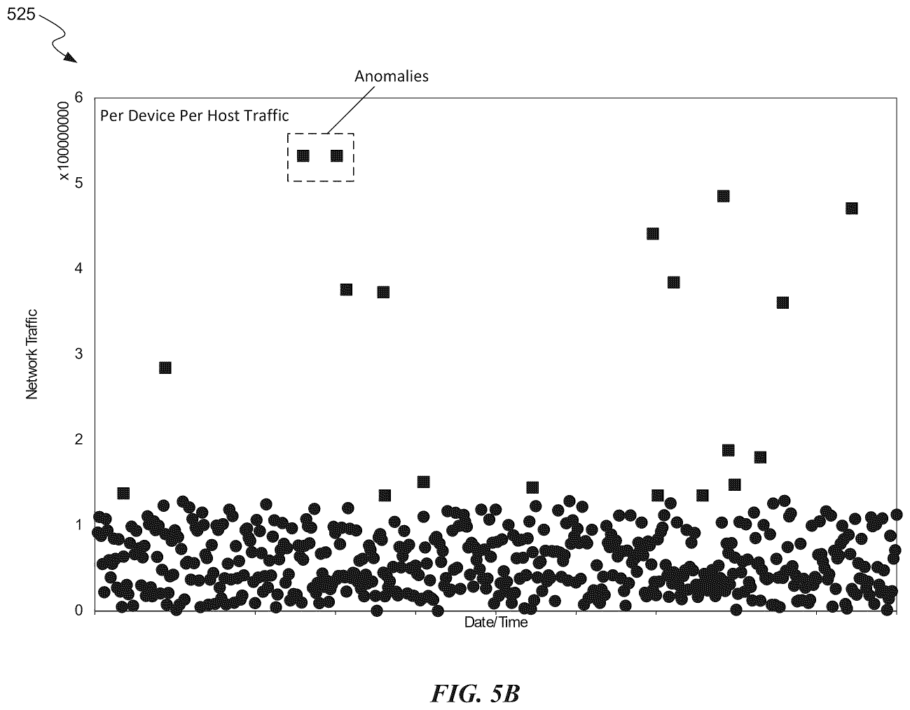

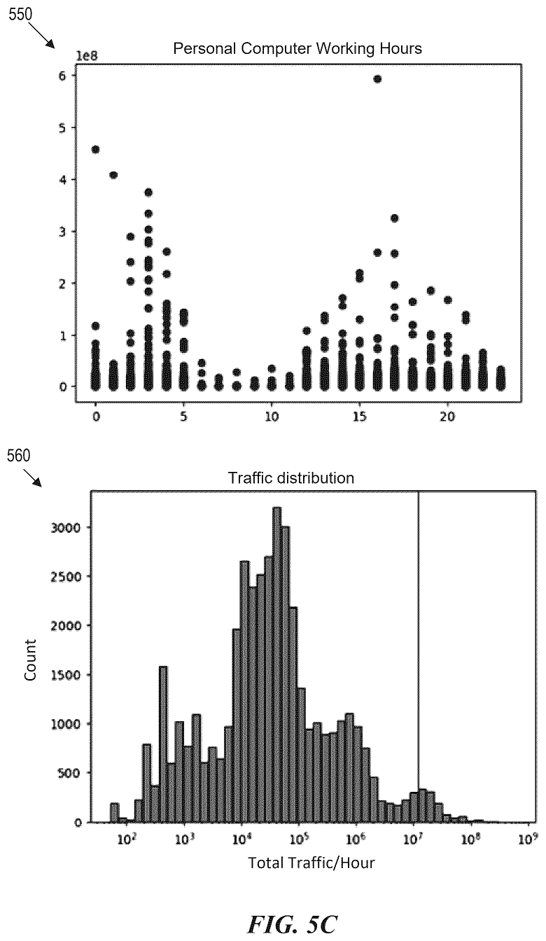

FIG. 5A illustrates a time-series plot 500 of total network traffic volume over time, for multiple hosts interacting with various devices or with a single device. The x-axis represents date and time, while the y-axis measures the total number of bytes transmitted. Different hosts are indicated in the legend on the right. The dataset for the time-series plot 500 provides insights into how traffic fluctuates over time across different host-device pairs.

The time-series plot 500 reveals distinct traffic spikes, with certain hosts exhibiting periodic bursts of data transfer. The traffic spikes could indicate scheduled updates, authentication requests, or data synchronization events, for example. For example, an authentication domain may experience increased activity during login attempts, software updates, or cloud synchronization operations, when authentication operations may be more likely to be carried out.

The time-series plot 500 indicates the traffic distribution across hosts. Some hosts can demonstrate consistent low-level traffic, while others can exhibit occasional surges in network activity. The presence of irregular spikes could indicate anomalous behavior, such as data exfiltration, an unauthorized file transfer, or a security event. For instance, if an internal IP address suddenly shows a high outbound data transfer, the traffic pattern may suggest a possible breach or unauthorized access.

From an anomaly detection perspective, time-series plot 500 is useful for establishing baselines of normal communication patterns and flagging deviations that may indicate cyber threats. If a device that typically exhibits low data exchange suddenly transmits large amounts of data, the device's behavior can be flagged for further investigation. The time-series plot 500 can help security analysts correlate traffic patterns with known attack techniques such as exfiltration (e.g., over command-and-control channels or another protocol), command-and-control activity, or denial-of-service attempts.

FIG. 5B illustrates a scatter plot analysis 525 of network traffic volume per device and host over time, highlighting regular traffic patterns and detected anomalies. The x-axis represents the date range, while the y-axis quantifies the total bytes transmitted in each session. Each data point in the figure corresponds to a recorded communication session, where circles represent regular traffic and squares indicate anomalous traffic volumes. The plot enables visual identification of deviations from expected network behavior, aiding in the detection of potential security threats.

The presence of high-volume traffic anomalies is evident, particularly in the upper left section of the scatter plot analysis 525, where isolated data points are circled and labeled as “Anomaly”. These points represent traffic volumes significantly higher than the rest of the dataset, suggesting that a device exhibited unexpected surges in data transmission. Such anomalies may indicate potential data exfiltration, unauthorized bulk transfers, or malicious activity. Additionally, sporadic anomalous data points scattered throughout the timeline suggest that anomalous traffic is not confined to a single event but occurs intermittently across different time periods.

From a baselining perspective, the scatter plot analysis 525 distinguishes between expected device-host traffic patterns and outliers that deviate significantly from historical trends. The circles forming a dense band near the bottom of the y-axis indicate consistent traffic levels, reinforcing the anomaly detection system's ability to establish a baseline for normal operations. Meanwhile, the outlier points appearing higher on the y-axis reflect unexpected bursts of traffic volume, which may warrant further investigation. If a device normally transmits low to moderate amounts of data but suddenly generates hundreds of megabytes of traffic, for example, such activity can be flagged for further analysis.

FIG. 5C illustrates two graphs that provide analysis on network traffic characteristics, focusing on traffic behavior in a personal computer over working hours for graph 550-1 and the overall distribution of traffic volume per hour for graph 550-2. Both graphs help in identifying typical usage patterns and detecting anomalies based on traffic volume fluctuations.

FIG. 5C illustrates a scatter plot visualization of network traffic volume recorded over a 24-hour period, showing how a personal computer generates network activity at different hours of the day as graph 550. The x-axis represents time in hours, where each point corresponds to a recorded traffic event occurring during a specific hour. The y-axis represents total network traffic volume in bytes, with a scale expressed in scientific notation (e.g., 1e8=100 million bytes or 100 MB). Each dot in the scatter plot represents a session where data was transmitted, with denser clusters indicating higher frequency of network activity.

The distribution in graph 550 indicates that two primary peaks of network activity occur, one between 0 and 6 hours and another between 12 and 18 hours. The early morning peak indicates that a significant amount of network traffic is generated during non-traditional working hours, possibly due to automated processes such as system updates, scheduled backups, or remote access activity. The second peak, which occurs around midday to late afternoon, aligns more closely with interactive user activity, suggesting that the computer is being actively used for tasks that involve network communication, such as web browsing, file transfers, or remote work applications.

The presence of isolated high-traffic outliers at different times can indicate anomalous, potentially nefarious, network activity. For example, the spike reaching above 500 MB to 600 MB raises questions about unusual or unexpected data transfers. If the device (e.g., a personal computer) is typically expected to exhibit lower traffic volumes, such large spikes may indicate bulk data uploads, software patches, video streaming, or even security incidents such as data exfiltration. The dense clustering of points at lower y-values suggests that most traffic sessions involve relatively small amounts of data, reinforcing that high-volume spikes are deviations from normal behavior. If a personal computer is expected to be inactive during certain hours but still exhibits significant network activity, the behavior may warrant further investigation from the anomaly detection system. Similarly, a sudden increase in outbound traffic during off-peak hours could be indicative of unauthorized data transfers or malware communication.

FIG. 5C also illustrates a histogram 560 depicting the distribution of network traffic volume per hour, measured in bytes per hour. The x-axis represents total network traffic per unit time (in bytes transferred per hour in histogram 560), displayed on a logarithmic scale ranging from 102 (100 bytes) to 10° (1 GB). The y-axis represents the count of occurrences, showing how frequently each range of traffic volume appears in the dataset. The histogram reveals the overall pattern of network traffic distribution and highlights a threshold (marked by a vertical line) at approximately 107 bytes per hour (10 MB), which may indicate a significant deviation from typical traffic behavior.

Furthermore, the count on the y-axis represents the number of hourly sessions that fall into each traffic range. In some embodiments, the label “Count” can refer to the number of occurrences of network traffic measurements within each bin (range of bytes per hour). The highest peak of the histogram, reaching approximately 3,000 occurrences, indicates that the greatest portion of network activity falls within a range of 104 to 106 bytes per hour (10 KB to 1 MB per hour). This indicates that the majority of sessions generate relatively small data exchanges, aligning with routine activities such as browsing, small file transfers, or low-volume communications.

For example, if a device that usually transmits moderate data volumes suddenly generates multiple sessions exceeding the 107 bytes/hour threshold, this could indicate anomalous activity such as data exfiltration, malware communication, or unauthorized bulk file transfers. The log scale ensures that both low-volume and high-volume traffic events are proportionally represented, preventing smaller values from being overshadowed by extreme outliers.

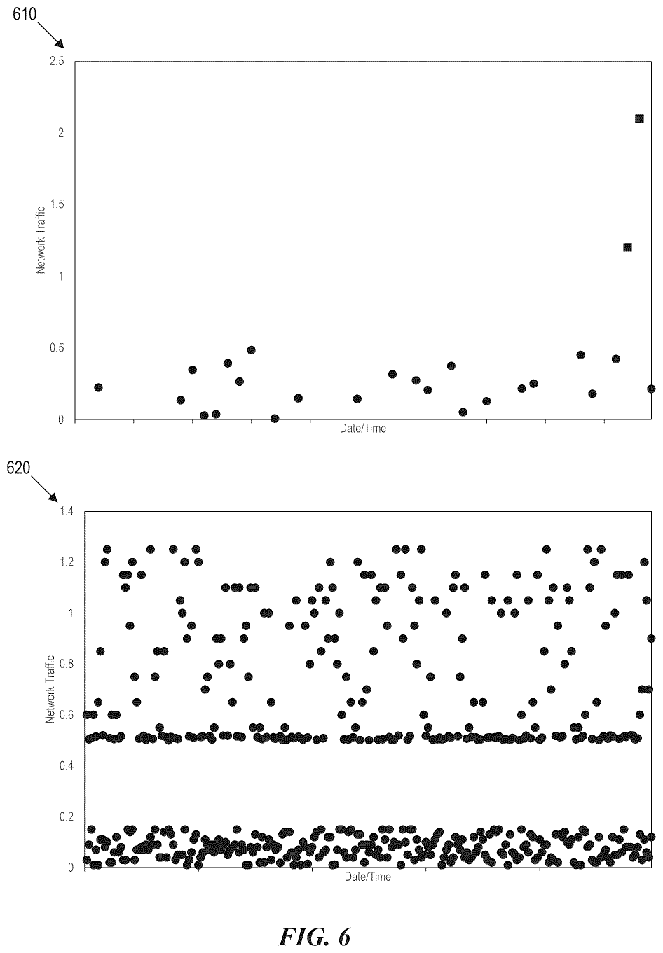

FIG. 6 illustrates a comparative analysis of network traffic data using two anomaly detection models, indicating how data points are classified as either anomalous or non-anomalous based on different perspectives of host-device interactions. Graph 610 focuses on traffic volume exchanged between a specific device and a host, while the graph 620 illustrates traffic volume between a single host and multiple devices. As shown in FIG. 6, the different models can identify anomalies differently.

Graph 610 displays a scatter plot of total bytes transmitted between a single device-host pair over time. The x-axis represents datetime, ranging from October 2023 to February 2024, while the y-axis represents the total bytes exchanged, measured in millions of bytes. Each circle data point represents a recorded network session that was not classified as an anomaly, while square data points represent specific device-host interactions highlighted in the dataset as potentially anomalous. The sparsity of data points suggests that this particular device communicates infrequently with the given host, with occasional spikes in traffic volume. The two data points in squares may represent high-priority traffic exchanges, for example. Based on graph 610 alone, these data points may be considered anomalous. Applying multiple models, however, can help determine whether potentially anomalous transfers are truly anomalous.

Graph 620 expands the scope of analysis to traffic between a single host and multiple devices, allowing for a broader assessment of network activity. The x-axis again represents datetime (e.g., ranging from October 2023 to February 2024), while the y-axis represents total bytes transmitted, now scaled in hundreds of millions (1e8) of bytes. Compared to graph 610, the graph 620 provides a significantly larger number of data points. Graph 620 displays a clustering of data points at various layers, where traffic volume appears to form distinct bands at different levels. The layers indicate recurring traffic patterns, which can correspond to baseline communication behaviors between the host and different device groups. Some data points exceed 1e8 bytes (100 MB) per session, representing high-volume transmissions, but these sessions were not flagged as anomalies by the detection models.

In FIG. 6, there is no clear agreement between graph 610 and graph 620 identifying certain sessions as anomalous. Thus, anomalous activity may not be identified.

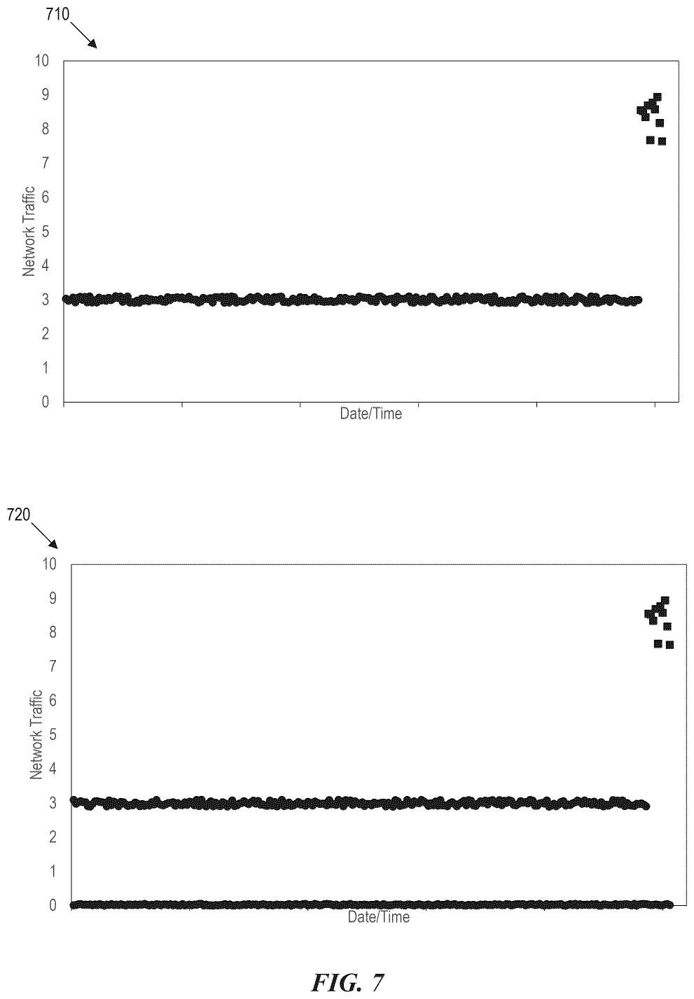

FIG. 7 illustrates a comparative analysis of network traffic data, depicting cases where both anomaly detection models identified anomalous activity. Graph 710 examines traffic volume exchanged between a specific device and a host, while the graph 720 shows traffic between a single host and multiple devices. The classification results indicate that certain traffic sessions were flagged as anomalies in both models, marking them as potential security risks and true anomalies. The synchronized detection across models reinforces confidence in the anomaly classification, suggesting that these traffic spikes represent genuine deviations from expected behavior.

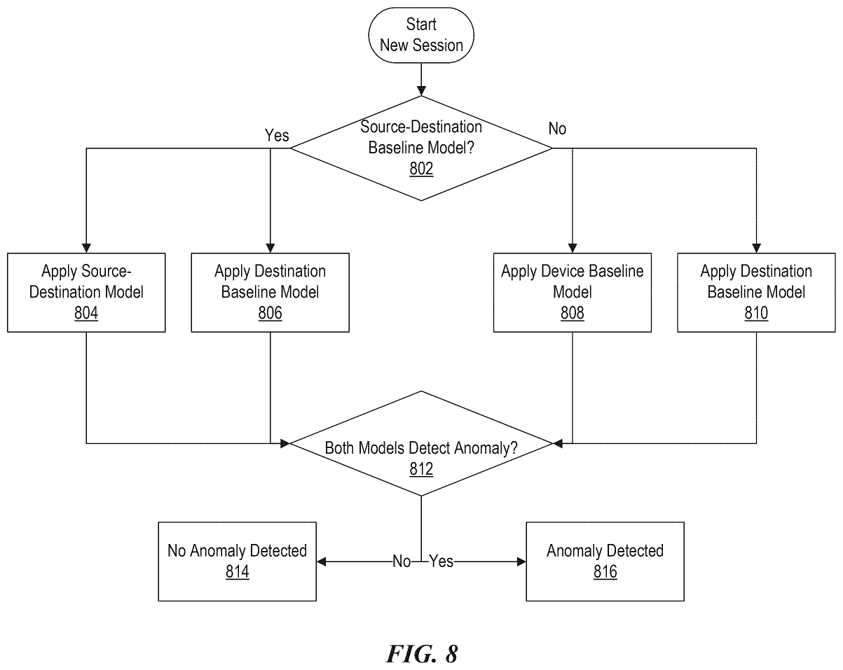

FIG. 8 is a block diagram that illustrates an example process for classifying a session according to some embodiments. At operation 802, a system can, for a particular session between a source and destination (e.g., device and host), determine if there is an existing source-destination baseline model. If so, the system can apply the source-destination baseline model at operation 804 and a destination baseline model at operation 806. The source-destination baseline model can be a model for traffic between the specific source and destination, while the destination baseline model can be a model for traffic between the destination and a plurality of other systems. If, at operation 802, there is no source-destination baseline model, the system can apply a device baseline model at operation 808 and the destination baseline model at operation 810. The device baseline model (also referred to as a source baseline model) can model traffic between the source and a plurality of destinations. Regardless of the outcome of operation 802, two models are applied, although the specific models are different in different circumstances. At operation 812, the system can determine if both models detected an anomaly. If not, the system can determine that no anomaly was detected at operation 814. If both models agree that there was an anomaly, the system can determine that there was an anomaly at operation 816.

### EXAMPLE EMBODIMENTS

Embodiment 1. A computer-implemented method for identifying anomalous network activity, the computer-implemented method comprising: accessing network communication session data for a session between a source and a destination; determining, for the source and destination, if there is a source-destination baseline model, wherein the source-destination baseline model is a model indicative of expected network communications between the source and the destination; when the source-destination baseline model exists: determining, using the source-destination baseline model, whether the network communication session data indicates anomalous activity; determining, a destination baseline model, whether the network communication session data indicates anomalous activity, wherein the destination baseline model is a model indicative of expected network communication between the destination and a plurality of devices; when anomalous activity is determined using both the source-destination baseline model and the destination baseline model: determining that the session included anomalous network activity; when anomalous network activity is not determined using at least one of the source-destination model or the destination baseline model: determining that the session did not include anomalous network activity; when the source-destination baseline model does not exist: determining, using a source baseline model, whether the network communication session data indicates anomalous activity, wherein the source baseline model is a model indicative of expected network communication between the source and a plurality of destinations; determining, a destination baseline model, whether the network communication session data indicates anomalous activity, wherein the destination baseline model is a model indicative of expected network communication between the destination and a plurality of devices; when anomalous activity is determined using both the source baseline model and the destination baseline model: determining that the session included anomalous network activity; when anomalous network activity is not determined using at least one of the source model or the destination baseline model: determining that the session did not include anomalous network activity; when anomalous network activity is determined: performing an action comprising at least one of: generating an alert, generating an event in a log, restricting network communication of the source, restricting network communication to the destination or generating an activity based on which an action can be carried out, the activity comprising at least one of: alerting, enforcing, quarantining, tagging, or vulnerability scanning.

Embodiment 2. The computer-implemented method of embodiment 1, wherein the source-destination baseline model is determined by: accessing network session data for network communications between the source and the destination over a period of time; applying a clustering model to the network session data to determine a plurality of clusters; determining that a cluster of the plurality of clusters includes fewer than a threshold number of data points; identifying one or more relevant points in one or more other clusters of the plurality of clusters, wherein the one or more relevant points comprise one or more points that are within a threshold similarity of points in the cluster; moving the one or more relevant points to the cluster.

Embodiment 3. The computer-implemented method of embodiment 2, wherein: the period of time is six months or about six months and the threshold number of data points is six or about six; or wherein the period of time is 90 days or about 90 days and the threshold number of data points is 30 or about 30.

Embodiment 4. A computer-implemented method for identifying anomalous network activity, the computer-implemented method comprising: accessing network communication session data for a session between a source and a destination; selecting a first baseline model; selecting a second baseline model, wherein the second baseline model is different from the first baseline model; applying the first baseline model to make a first determination of whether the network communication session data indicates anomalous activity; applying the second baseline model to make a second determination of whether the network communication session data indicates anomalous activity; when the first determination indicates anomalous activity and the second determination indicates anomalous activity: determining that the session included anomalous network activity.

Embodiment 5. The computer-implemented method of embodiment 4, further comprising, when the first determination indicates anomalous network activity and the second determination indicates anomalous activity: performing an action comprising at least one of: generating an alert, generating an event in a log, restricting network communication of the source, or restricting network communication to the destination.

Embodiment 6. The computer-implemented method of embodiment 4 or 5, wherein the first determination is based on determining that a first z score for the network communication session data is above a first threshold amount, and wherein the second determination is based on determining that a second z score for the network communication session data is above a second threshold amount.

Embodiment 7. The computer-implemented method of embodiment 4, 5, or 6, wherein the first determination is based on determining that a first modified z score for the network communication session data is above a first threshold amount, wherein the second determination is based on determining that a second modified z score for the network communication session data is above a second threshold amount, wherein the first modified z score is determined by subtracting a first median value associated with the first baseline model from a first value associated with the network communication session data and dividing a result of the subtracting by a first median absolute deviation associated with the first baseline model, and wherein the second modified z score is determined by subtracting a second median value associated with the second baseline model from a second value associated with the network communication session data and dividing a result of the subtracting by a second median absolute deviation associated with the second baseline model.

Embodiment 8. The computer-implemented method of embodiment 4, 5, 6, or 7, wherein the first baseline model is determined by: accessing network session data for network communications over a period of time; applying a clustering model to the network session data to determine a plurality of clusters; determining that a cluster of the plurality of clusters includes fewer than a threshold number of data points; identifying one or more relevant points in one or more other clusters of the plurality of clusters, wherein the one or more relevant points comprise one or more points that are within a threshold similarity of points in the cluster; moving the one or more relevant points to the cluster.

Embodiment 9. The computer-implemented method of embodiment 8, wherein the first baseline model includes points included in clusters with at least the threshold number of data points and does not include points included in clusters with fewer than the threshold number of data points.

Embodiment 10. The computer-implemented method of embodiment 8 or 9, wherein the plurality of clusters is determined using k-means clustering.

Embodiment 11. The computer-implemented method of embodiment 8, 9, or 10, wherein the plurality of clusters is determined using an OPTICS algorithm.

Embodiment 12. The computer-implemented method of any of embodiments 4-11, wherein the first baseline model is a source-destination baseline model, and wherein the second baseline model is a destination baseline model.

Embodiment 13. The computer-implemented method of any of embodiments 4-11, wherein the first baseline model is a source baseline model, and wherein the second baseline model is a destination baseline model.

Embodiment 14. The computer-implemented method of any of embodiments 4-11, wherein selecting the first baseline model and selecting the second baseline model is based at least in part on determining an existence of a source-destination baseline model indicating baseline network activity between the source and the destination.

Embodiment 15. The computer-implemented method of any of embodiments 4-14, further comprising, when the first determination indicates anomalous network activity and the second determination indicates anomalous activity: determining a validity indication, wherein the validity indication is based on a ratio of historical anomalous sessions to total historical sessions and a total number of historical anomalous sessions.

Embodiment 16. A system for identifying anomalous network activity, the system comprising: at least one processor; and a non-transitory storage medium having instructions stored thereon that, when executed by the at least one processor, cause the system to: access network communication session data for a session between a source and a destination; select a first baseline model; select a second baseline model, wherein the second baseline model is different from the first baseline model; apply the first baseline model to make a first determination of whether the network communication session data indicates anomalous activity; apply the second baseline model to make a second determination of whether the network communication session data indicates anomalous activity; when the first determination indicates anomalous activity and the second determination indicates anomalous activity: determine that the session included anomalous network activity.

Embodiment 17. The system of embodiment 16, wherein the instructions are further configured to cause the system to, when the first determination indicates anomalous network activity and the second determination indicates anomalous activity: perform an action comprising at least one of: generating an alert, generating an event in a log, restricting network communication of the source, or restricting network communication to the destination.

Embodiment 18. The system of embodiment 16 or 17, wherein the first determination is based on determining that a first modified z score for the network communication session data is above a first threshold amount, wherein the second determination is based on determining that a second modified z score for the network communication session data is above a second threshold amount, wherein the first modified z score is determined by subtracting a first median value associated with the first baseline model from a first value associated with the network communication session data and dividing a result of the subtracting by a first median absolute deviation associated with the first baseline model, and wherein the second modified z score is determined by subtracting a second median value associated with the second baseline model from a second value associated with the network communication session data and dividing a result of the subtracting by a second median absolute deviation associated with the second baseline model.

Embodiment 19. The system of embodiment 16, 17, or 18, wherein the first baseline model is determined by: accessing network session data for network communications over a period of time; applying a clustering model to the network session data to determine a plurality of clusters; determining that a cluster of the plurality of clusters includes fewer than a threshold number of data points; identifying one or more relevant points in one or more other clusters of the plurality of clusters, wherein the one or more relevant points comprise one or more points that are within a threshold similarity of points in the cluster; moving the one or more relevant points to the cluster.

Embodiment 20. The system of embodiment 16, 17, 18, or 19, wherein the instructions are further configured to cause the system to, when the first determination indicates anomalous network activity and the second determination indicates anomalous activity: determine a validity indication, wherein the validity indication is based on a ratio of historical anomalous sessions to total historical sessions and a total number of historical anomalous sessions.

Embodiment 21. A method for detecting anomalous network activity, the method comprising: collecting network activity data for a plurality of systems over a period time; determining a plurality of baselines from the collected network activity; and determining when a network activity session deviates from one or more baselines of the plurality of baselines by more than a threshold amount.

Embodiment 22. The method of embodiment 21, wherein the one or more baselines comprise at least two baselines.

Embodiment 23. The method of embodiment 21 or 22, wherein determining when the network activity session deviates from one or more baselines comprises computing: one or more z scores, one or more modified z scores, or one or more z scores and one or more modified z scores.

### Computer Systems

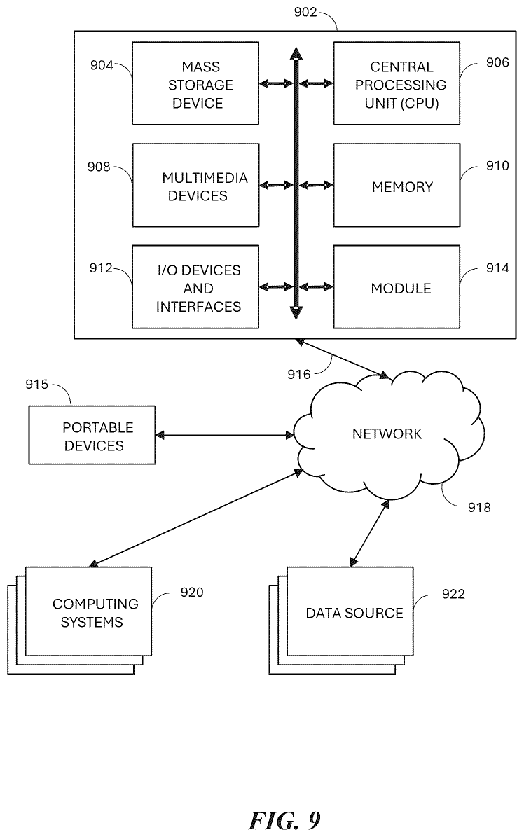

FIG. 9 is a block diagram depicting an embodiment of a computer hardware system configured to run software for implementing anomaly detection and any systems, methods, and devices disclosed herein. The example computer system 902 is in communication with one or more computing systems 920 and/or one or more data sources 922 via one or more networks 918. While FIG. 9 illustrates an embodiment of a computing system 902, it is recognized that the functionality provided for in the components and modules of computer system 902 may be combined into fewer components and modules, or further separated into additional components and modules.

The computer system 902 can include a module 914 that carries out the functions, methods, acts, and/or processes described herein. The module 914 is executed on the computer system 902 by a central processing unit 906 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within specially designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 902 includes one or more processing units (CPU) 906, which may include a microprocessor. The computer system 902 further includes a physical memory 910, such as random-access memory (RAM) for temporary storage of information, a read only memory (ROM) for permanent storage of information, and a mass storage device 904, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 902 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 902 includes one or more input/output (I/O) devices and interfaces 912, such as a keyboard, mouse, touch pad, and printer. The I/O devices and interfaces 912 can include one or more display devices, such as a monitor, which allows the visual presentation of data to a user. More particularly, a display device provides for the presentation of graphical user interfaces (GUIs) as application software data, and multi-media presentations, for example. The I/O devices and interfaces 912 can also provide a communications interface to various external devices. The computer system 902 may include one or more multi-media devices 908, such as speakers, video cards, graphics accelerators, and microphones, for example.

The computer system 902 may run on a variety of computing devices, such as a server, a Windows server, a Structure Query Language server, a Unix Server, a personal computer, a laptop computer, and so forth. In other embodiments, the computer system 902 may run on a cluster computer system, a mainframe computer system and/or other computing system suitable for controlling and/or communicating with large databases, performing high volume transaction processing, and generating reports from large databases. The computing system 902 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a GUI, among other things.

The computer system 902 illustrated in FIG. 9 is coupled to a network 918, such as a LAN, WAN, or the Internet via a communication link 916 (wired, wireless, or a combination thereof). Network 918 communicates with various computing devices and/or other electronic devices. Network 918 is communicating with one or more computing systems 920 and one or more data sources 922. The module 914 may access or may be accessed by computing systems 920 and/or data sources 922 through a web-enabled user access point. Connections may be a direct physical connection, a virtual connection, or other connection type. The web-enabled user access point may include a browser module that uses text, graphics, audio, video, and other media to present data and to allow interaction with data via the network 918.

Access to the module 914 of the computer system 902 by computing systems 920 and/or by data sources 922 may be through a web-enabled user access point such as the computing systems' 920 or data source's 922 personal computer, cellular phone, smartphone, laptop, tablet computer, e-reader device, audio player, or another device capable of connecting to the network 918. Such a device may have a browser module that is implemented as a module that uses text, graphics, audio, video, and other media to present data and to allow interaction with data via the network 918.

The output module may be implemented as a combination of an all-points addressable display such as a cathode ray tube (CRT), a liquid crystal display (LCD), a plasma display, or other types and/or combinations of displays. The output module may be implemented to communicate with input devices 912 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may include a keyboard, roller ball, pen and stylus, mouse, trackball, voice recognition system, or pre-designated switches or buttons. The output device(s) may include a speaker, a display screen, a printer, or a voice synthesizer. In addition, a touch screen may act as a hybrid input/output device. In another embodiment, a user may interact with the system more directly such as through a system terminal connected without communications over the Internet, a WAN, or LAN, or similar network.

In some embodiments, the system 902 may include a physical or logical connection established between a remote microprocessor and a mainframe host computer for the express purpose of uploading, downloading, or viewing interactive data and databases on-line in real time. The remote microprocessor may be operated by an entity operating the computer system 902, including the client server systems or the main server system, an/or may be operated by one or more of the data sources 922 and/or one or more of the computing systems 920. In some embodiments, terminal emulation software may be used on the microprocessor for participating in the micro-mainframe link.

In some embodiments, computing systems 920 that are internal to an entity operating the computer system 902 may access the module 914 internally as an application or process run by the CPU 906.

In some embodiments, one or more features of the systems, methods, and devices described herein can utilize a URL and/or cookies, for example, for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 902 may include one or more internal and/or external data sources (for example, data sources 922). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 902 may also access one or more data sources 922. The data sources 922 may be stored in a database or data repository. The computer system 902 may access the one or more data sources 922 through a network 918 or may directly access the database or data repository through I/O devices and interfaces 912. The data repository storing the one or more data sources 922 may reside within the computer system 902.

### ADDITIONAL EMBODIMENTS

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, or for example±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A computer-implemented method for identifying anomalous network activity, the computer-implemented method comprising:
accessing network communication session data for a session between a source and a destination;
determining, for the source and destination, if there is a source-destination baseline model, wherein the source-destination baseline model is a model indicative of expected network communications between the source and the destination;
when the source-destination baseline model exists:
determining, using the source-destination baseline model, whether the network communication session data indicates anomalous activity;
determining, a destination baseline model, whether the network communication session data indicates anomalous activity, wherein the destination baseline model is a model indicative of expected network communication between the destination and a plurality of devices;
when anomalous activity is determined using both the source-destination baseline model and the destination baseline model:
determining that the session included anomalous network activity;
when anomalous network activity is not determined using at least one of the source-destination model or the destination baseline model:
determining that the session did not include anomalous network activity;
when the source-destination baseline model does not exist:
determining, using a source baseline model, whether the network communication session data indicates anomalous activity, wherein the source baseline model is a model indicative of expected network communication between the source and a plurality of destinations;
determining, a destination baseline model, whether the network communication session data indicates anomalous activity, wherein the destination baseline model is a model indicative of expected network communication between the destination and a plurality of devices;
when anomalous activity is determined using both the source baseline model and the destination baseline model:
determining that the session included anomalous network activity;
when anomalous network activity is not determined using at least one of the source model or the destination baseline model:
determining that the session did not include anomalous network activity;
when anomalous network activity is determined:
performing an action comprising at least one of: generating an alert, generating an event in a log, restricting network communication of the source, restricting network communication to the destination or generating an activity based on which an action can be carried out, the activity comprising at least one of: alerting, enforcing, quarantining, tagging, or vulnerability scanning.

2. The computer-implemented method of claim 1, wherein the source-destination baseline model is determined by:
accessing network session data for network communications between the source and the destination over a period of time;
applying a clustering model to the network session data to determine a plurality of clusters;
determining that a cluster of the plurality of clusters includes fewer than a threshold number of data points;
identifying one or more relevant points in one or more other clusters of the plurality of clusters, wherein the one or more relevant points comprise one or more points that are within a threshold similarity of points in the cluster; and
moving the one or more relevant points to the cluster.

3. The computer-implemented method of claim 2, where the clustering model is an OPTICS clustering model.

4. A computer-implemented method for identifying anomalous network activity, the computer-implemented method comprising:
accessing network communication session data for a session between a source and a destination;
selecting a first baseline model;
selecting a second baseline model, wherein the second baseline model is different from the first baseline model;
applying the first baseline model to make a first determination of whether the network communication session data indicates anomalous activity;
applying the second baseline model to make a second determination of whether the network communication session data indicates anomalous activity; and
when the first determination indicates anomalous activity and the second determination indicates anomalous activity:
determining that the session included anomalous network activity.

5. The computer-implemented method of claim 4, further comprising, when the first determination indicates anomalous network activity and the second determination indicates anomalous activity:
performing an action comprising at least one of: generating an alert, generating an event in a log, restricting network communication of the source, or restricting network communication to the destination.

6. The computer-implemented method of claim 4, wherein the first determination is based on determining that a first z score for the network communication session data is above a first threshold amount, and
wherein the second determination is based on determining that a second z score for the network communication session data is above a second threshold amount.

7. The computer-implemented method of claim 4, wherein the first determination is based on determining that a first modified z score for the network communication session data is above a first threshold amount,
wherein the second determination is based on determining that a second modified z score for the network communication session data is above a second threshold amount,
wherein the first modified z score is determined by subtracting a first median value associated with the first baseline model from a first value associated with the network communication session data and dividing a result of the subtracting by a first median absolute deviation associated with the first baseline model, and
wherein the second modified z score is determined by subtracting a second median value associated with the second baseline model from a second value associated with the network communication session data and dividing a result of the subtracting by a second median absolute deviation associated with the second baseline model.

8. The computer-implemented method of claim 4, wherein the first baseline model is determined by:
accessing network session data for network communications over a period of time;
applying a clustering model to the network session data to determine a plurality of clusters;
determining that a cluster of the plurality of clusters includes fewer than a threshold number of data points;
identifying one or more relevant points in one or more other clusters of the plurality of clusters, wherein the one or more relevant points comprise one or more points that are within a threshold similarity of points in the cluster; and
moving the one or more relevant points to the cluster.

9. The computer-implemented method of claim 8, wherein the first baseline model includes points included in clusters with at least the threshold number of data points and does not include points included in clusters with fewer than the threshold number of data points.

10. The computer-implemented method of claim 8, wherein the plurality of clusters is determined using k-means clustering.

11. The computer-implemented method of claim 8, wherein the plurality of clusters is determined using an OPTICS algorithm.

12. The computer-implemented method of claim 4, wherein the first baseline model is a source-destination baseline model, and wherein the second baseline model is a destination baseline model.

13. The computer-implemented method of claim 4, wherein the first baseline model is a source baseline model, and wherein the second baseline model is a destination baseline model.

14. The computer-implemented method of claim 4, wherein selecting the first baseline model and selecting the second baseline model is based at least in part on determining an existence of a source-destination baseline model indicating baseline network activity between the source and the destination.

15. The computer-implemented method of claim 4, further comprising, when the first determination indicates anomalous network activity and the second determination indicates anomalous activity:
determining a validity indication, wherein the validity indication is based on a ratio of historical anomalous sessions to total historical sessions and a total number of historical anomalous sessions.

16. A system for identifying anomalous network activity, the system comprising:
at least one processor; and
a non-transitory storage medium having instructions stored thereon that, when executed by the at least one processor, cause the system to:
access network communication session data for a session between a source and a destination;
select a first baseline model;
select a second baseline model, wherein the second baseline model is different from the first baseline model;
apply the first baseline model to make a first determination of whether the network communication session data indicates anomalous activity;
apply the second baseline model to make a second determination of whether the network communication session data indicates anomalous activity;
when the first determination indicates anomalous activity and the second determination indicates anomalous activity:
determine that the session included anomalous network activity.

17. The system of claim 16, wherein the instructions are further configured to cause the system to, when the first determination indicates anomalous network activity and the second determination indicates anomalous activity:
perform an action comprising at least one of: generating an alert, generating an event in a log, restricting network communication of the source, or restricting network communication to the destination.

18. The system of claim 16, wherein the first determination is based on determining that a first modified z score for the network communication session data is above a first threshold amount,
wherein the second determination is based on determining that a second modified z score for the network communication session data is above a second threshold amount,
wherein the first modified z score is determined by subtracting a first median value associated with the first baseline model from a first value associated with the network communication session data and dividing a result of the subtracting by a first median absolute deviation associated with the first baseline model, and
wherein the second modified z score is determined by subtracting a second median value associated with the second baseline model from a second value associated with the network communication session data and dividing a result of the subtracting by a second median absolute deviation associated with the second baseline model.

19. The system of claim 16, wherein the first baseline model is determined by:
accessing network session data for network communications over a period of time;
applying a clustering model to the network session data to determine a plurality of clusters;
determining that a cluster of the plurality of clusters includes fewer than a threshold number of data points;
identifying one or more relevant points in one or more other clusters of the plurality of clusters, wherein the one or more relevant points comprise one or more points that are within a threshold similarity of points in the cluster; and
moving the one or more relevant points to the cluster.

20. The system of claim 16, wherein the instructions are further configured to cause the system to, when the first determination indicates anomalous network activity and the second determination indicates anomalous activity:
determine a validity indication, wherein the validity indication is based on a ratio of historical anomalous sessions to total historical sessions and a total number of historical anomalous sessions.
